(19) United States
(12) Patent Application Publication
(10) Pub. No.: US 2011/0129625 A1
(43) Pub. Date: Jun. 2, 2011

(54) Manufacturing Containers

(75) Inventor: Bertram Alan Lancaster, Te Awamutu (NZ)

(73) Assignee: B.A. LANCASTER LIMITED, Papakura (NZ)

(21) Appl. No.: 13/056,658

(22) PCT Filed: Jul. 23, 2009
(86) PCT No.: PCT/NZ09/00146

§ 371 Date: Jan. 29, 2011

(30) Foreign Application Priority Data
Jul. 29, 2008 (NZ) 570180

(51) Int. Cl. B32B 1/02; B32B 29/00; B32B 37/02; B32B 37/12; B32B 37/20; B32B 38/10

(52) U.S. Cl. 428/34.2; 428/537.5; 156/60; 156/184; 156/470

(57) ABSTRACT

A method and apparatus for constructing a sheet of laminate material, which may be fibreboard, the method including the steps of treating a sheet of planar material with an adhesive, placing a second sheet of planar material against the first sheet such that the sheets bond together to form the sheet of laminate material, characterised by the additional step of removing adhesive from a first portion of the first sheet of planar material such that substantially less bonding occurs between the first and second sheets of planar material at the portion of planar material from which adhesive has been removed than at a portion of planar material from which adhesive has not been removed, wherein the portion of the planar material from which adhesive has been removed forms a controlled area of weakness in the laminate material. A collapsible container made from the laminate material is also claimed.

### TECHNICAL FIELD

The present invention relates to manufacturing of fibreboard containers. The invention has particular application to the manufacture of collapsible fibreboard containers.

### BACKGROUND ART

It is common practice in the packaging industry to utilise fibreboard containers for storage and transportation of goods.

Containers made from fibreboard are particularly strong relative to conventional packing materials such as cardboard boxes. Because of the strength of fibreboard containers, they can be used to transport or store heavier items than is possible with conventional cardboard boxes of the same thickness as a fibreboard container.

Fibreboard containers typically have a fibreboard tube with a top and bottom to enclose the contents and form a closed pack. The tube portion of the fibreboard container bears the majority of the load imparted to the container. The strength of the tube portion of the fibreboard container also permits vertical stacking of laden containers.

The durability and strength of fibreboard is derived from its manner of manufacture. To form a cylindrical fibreboard container, a sheet of paper is treated with adhesive, and is then wound about a mandrel. Successive layers of paper then bond to adjacent paper layers due to the adhesive.

The number of times a paper is wound about the mandrel depends on the strength required and the end use of the resulting container; the more layers of paper that are wound onto the mandrel, the stronger the resulting container.

A pressure roller may be used to enhance the paper bonding process as successive layers of glued paper are wound onto the mandrel. This further encourages the layers of paper to bond together.

The end result is a particularly robust container which is resistant to bending, knocks, and other events that may occur when the container is in transit or at a storage facility.

However, the same properties of fibreboard which make containers made from this material so robust, also makes it difficult to store empty fibreboard containers when they are not required.

Conventional fibreboard containers cannot be folded or flattened without damaging the integrity of the container. Because of the relative stiffness and thickness of the fibreboard, it cannot bend like conventional cardboard when force is applied; rather, the material tears or cracks.

Therefore, a typical container made from fibreboard takes up more storage space when empty than other comparable forms of collapsible packaging. Thus, what may be valuable storage, transport, and floor space needs to be dedicated to the storage of fibreboard containers when they are not in use.

Furthermore, the same space constraints limit the total number of fibreboard containers which can be stored at various stages of manufacture, during delivery to the customer, and when empty at the customer's premises.

It has also been found that re-use of fibreboard containers can be constrained due to the high costs of returning the empty fibreboard containers due to the space they take up in transit.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

According to one aspect of the present invention, there is provided a method of constructing a sheet of laminate material, the method including the steps of:
a) treating a sheet of planar material with an adhesive,
b) placing a second sheet of planar material against the first sheet such that the sheets bond together to form the sheet of laminate material,
   characterised by the additional step of:
c) removing adhesive from a first portion of the first sheet of planar material such that substantially less bonding occurs between the first and second sheets of planar material at the portion of planar material from which adhesive has been removed than at a portion of planar material from which adhesive has not been removed, wherein the portion of the planar material from which adhesive has been removed forms a controlled area of weakness in the laminate material.

According to another aspect of the present invention, there is provided a method of constructing a sheet of laminate material as described above but including the steps of:
d) placing a third sheet of planar material against the second sheet of planar material, wherein the second sheet of planar material or the third sheet of planar material has been treated with adhesive,
e) removing adhesive from a second portion of the second or third sheets of planar material such that substantially less bonding occurs between the second and third sheets of planar material at the second portion than at a portion of planar material from which adhesive has not been removed, wherein the first portion of the first sheet of planar material and the second portion of the second sheet of planar material substantially correspond with each other to form a controlled area of weakness in the laminate material.

According to another aspect of the present invention, there is provided a sheet of laminate material, the laminate material including

a plurality of layers of planar material, wherein a first portion of each layer is bonded to its adjacent layer with adhesive,
characterised in that a second portion of each layer of planar material is prepared by removing the adhesive applied to the second portion, such that the bonding between adjacent layers is weaker at the second portion.

According to another aspect of the present invention, there is provided a method of constructing a laminate material from a sheet of planar material, the method including the steps of:
a) treating a sheet of planar material with an adhesive,
b) winding the planar material about a mandrel to form the laminate material from a plurality of layers of the planar material, and
   characterised by the additional steps of:
c) removing adhesive from a first portion of a first layer of the planar material, and
d) removing adhesive from a portion of an adjacent layer of planar material corresponding to the first portion of the first layer of the planar material, wherein the portions of planar material from which the adhesive has been removed forms a controlled area of weakness in the laminate material.

The laminate material may be any material which is constructed from a plurality of layers of material. For example, the laminate material may be formed from sheets of laminate wood or paper.

Preferably, the laminate material is fibreboard. Fibreboard should be understood to mean a material constructed from a length of paper treated with adhesive, which is wound onto a mandrel.

The planar material may be any thin malleable material such as a sheet of paper, plastic film, cardboard or similar sheet material. The planar material may be held upon a reel or spool and unwound as required, and thus may be thought of as a web of material.

In preferred embodiments of the present invention, the planar material is unwound from a reel or spool and passed along a series of rollers to be wound upon the mandrel to form a container.

One of the rollers is a glue roller, which treats the planar material as it passes over or under the roller by applying adhesive to the planar material prior to being wound onto the mandrel. Persons skilled in the art will appreciate that adhesive will not be applied to the surface of the planar material that is in immediate contact with the mandrel as this may result in the planar material bonding to the mandrel which clearly is undesirable.

A mandrel should be understood to be a member for forming an object having substantially the same or a similar profile as the mandrel. The object is formed by winding a sheet of planar material around a contact surface of the mandrel, such that the material takes on the profile of the mandrel.

Preferably, a press roller is used to contact the mandrel such that some pressure is applied to the planar material on the mandrel. This encourages and/or accelerates bonding between the layers of planar material which have not had the adhesive removed.

However, persons skilled in the art will appreciate that if the planar material is under sufficient tension as it is wound upon the mandrel, the tension along may be sufficient pressure to encourage bonding, without the need for a press roller. Tension may be increased by the use of a brake on the reel holding the planar material. In some embodiments of the present invention, tensioning rollers may also be used to act upon the material being wound on the mandrel.

This is particularly preferred when using a mandrel having defined sides as, in contrast to a mandrel of circular cross-section, there can be variation in speeds at which paper is wound onto the mandrel as the paper is layered on to the corners of the mandrel. Tensioning rollers may smooth out the tension by taking up slack or feeding more paper, depending on the speed variation of the planar material as it is wound onto the mandrel.

In preferred embodiments of the present invention, the planar material is Kraft paper. However, persons skilled in the art will appreciate that other materials may be used, such as cardboard.

A portion should be understood to mean a section or segment of the planar material. For example, the portion may be a strip across the width or length of the planar material.

An adjacent layer should be understood to mean the layer of planar material overlaying a first layer of planar material. The adhesive treated portions and the portions of each layer from which adhesive has been removed are such that in cross-section, there is a band of well bonded planar material and a band of less well bonded planar material. The band of less well bonded planar material should be understood to be the controlled area of weakness.

It is important to note that the successive layers of the planar material are indexed or synchronised so that the bonded and weakly bonded portions of the planar material line up to form a band of bonded and weakly bonded planar material. This may be used to form fold lines for a collapsible container made from the laminate material.

Prepared should be understood to mean a process by which the planar material is manipulated to reduce bonding between adjacent layers of the planar material at specific portions of the planar material.

In preferred embodiments of the present invention, the planar material may be prepared by removing some, or all, of the adhesive at specific portions along the length of the planar material.

The adhesive may be removed using a variety of methods which would be readily apparent to a person skilled in the art. For example, the adhesive may be wiped off from the portion of planar material using suitably absorbent material such as a sponge, cotton roller, or the like.

Alternatively, the adhesive may be removed or moved to one side of the portion of planar material through the use of a blade or wiper engaging with the surface of the planar material.

It will be understood that the term “removed” is not meant to be limiting. Adhesive may be removed from the planar material altogether or alternatively may be removed or collected from one portion of the planar material and the collected adhesive redistributed on another portion of planar material.

Persons skilled in the art will appreciate that there may still be small amounts of adhesive remaining on portions from which the majority of adhesive has been removed using the present invention.

Thus, there may still be some limited bonding occurring between layers of planar material even at points where adhesive has been substantially removed. However, it will be appreciated that the strength of the bond at these points may be substantially weaker than at portions that have not had adhesive removed.

A blade should be understood to mean an implement which contacts, but does not cut, the planar material across at least a portion of its surface. The blade may be made of any suitable material, but preferably is a rubber blade or the like, which confers a degree of flexibility to the blade.

The blade may engage with the planar material in a variety of ways. For example, the blade may be mounted to an articulated arm or the like, which via cams or the like, moves to and from the planar material as it passes beneath the blade. The blade may also be mounted to a cam mechanism.

As the blade engages with the planar material upon the mandrel, adhesive is collected from the planar material on one side of the blade for a defined period of time, until the blade disengages with the planar material. The collected adhesive is either removed with the blade, or is simply left at the point of removal of the blade from the planar material.

The portion of the planar material which has passed the blade while the blade was engaged with the material has all, or a substantial amount, of the adhesive removed from its surface.

In some embodiments of the present invention, the blade may be fixed relative to the mandrel, depending on the configuration of the mandrel. In these embodiments, the mandrel may have chamfered corners. These corners are contacted by the fixed blade thus removing and/or collecting adhesive coating the planar material lying upon the corners of the mandrel. Thus, the corners of the mandrel correspond to the controlled area of weakness in the laminate material.

Other ways of configuring the blade to engage with the planar material will be readily apparent to persons skilled in the art.

Persons skilled in the art will appreciate that the position of the blade relative to the press roller is important. The press roller does get contaminated over time through contact with the planar material and the adhesive coating the planar material. This would also counteract the effects of the removal of the adhesive if the blade was positioned to engage with the planar material before the press roller contacts the planar material. Preferably, the blade would engage with the planar material after the press roller has contacted the material.

Persons skilled in the art will appreciate that the position of the blade may also depend on whether inside or outside winding is used. In inside winding, the glue roller, after allowing for the initial portion of the planar material, will apply adhesive to the planar material on its inner surface which is the side facing the mandrel. In this instance, the blade needs to be positioned after the glue rollers but before the planar material contacts the mandrel.

In outside winding, the glue roller applies adhesive to the outer surfaces of the planar material, which is the side of the material facing away from the mandrel as it is wound on. In this instance, the blade can be positioned after the point of contact of the planar material and mandrel. As discussed previously, in this instance, the blade is preferably positioned after the point of contact of the press roller on the mandrel, if a press roller is fitted.

In some embodiments of the present invention, the planar material may be prepared by controlling the amount of adhesive applied to the planar material.

For example, the adhesive may be applied to the planar material using segmented glue rollers or the like so that there is controlled application of adhesive to specific portions of the planar material.

In preferred embodiments of the present invention, the planar material is prepared by controlling the amount of pressure applied to the planar material during manufacture.

According to another aspect of the present invention there is provided a method for constructing a laminate material, which includes the steps of:
a) treating a sheet of planar material with an adhesive,
b) winding the planar material about a mandrel to form the laminate material from a plurality of layers of the planar material, and
c) applying pressure to a first portion of the planar material such that substantially stronger bonding occurs between the layers of planar material corresponding to the first portion of the planar material than between the layers of material corresponding to a second portion of planar material,
   wherein the second portion of planar material forms a controlled area of weakness.

According to another aspect of the present invention there is provided a method for constructing a laminate material substantially as described above including the step of,
d) reducing the application of pressure to the planar material at the controlled area of weakness.

According to yet another aspect of the present invention there is provided a mandrel for use in forming a laminate material, the mandrel including;

a contact surface,
characterised in that the contact surface includes a pressure relief area configured to form a controlled area of weakness in the laminate material.

According to another aspect of the present invention there is provided a press roller for use with a mandrel to form a laminate material, the press roller including;

a contact surface,
characterised in that the contact surface includes a pressure relief area configured to form a controlled area of weakness in the laminate material.

According to another aspect of the present invention, there is provided a laminate material constructed using a mandrel substantially as described above, wherein the laminate material includes a plurality of layers of planar material wherein a first portion of each layer is bonded to its adjacent layer with adhesive,

characterised in that
a second portion of each layer of planar material is prepared by applying more pressure to the first portion of planar material than to the second portion of the planar material to reduce the adhesive bonding between adjacent layers at the second portion, such that a controlled area of weakness is formed in the laminate material.

According to another aspect of the present invention, there is provided a laminate material constructed using a press roller substantially as described above, wherein the laminate material includes a plurality of layers of planar material, wherein a first portion of each layer is bonded to its adjacent layer with adhesive,

characterised in that
a second portion of each layer of planar material is prepared by applying more pressure to the first portion of than to the second portion of the planar material to reduce the adhesive bonding between adjacent layers at the second portion, such that a controlled area of weakness is formed in the laminate material.

The planar material may be any thin malleable material such as a sheet of paper, plastic film, cardboard or similar sheet material. The planar material may be held upon a reel or spool and unwound as required, and thus may be thought of as a web of material.

In preferred embodiments of the present invention, the planar material is unwound from a reel or spool and passed along a series of rollers to be wound upon the mandrel to form a container.

In preferred embodiments of the present invention, the planar material is Kraft paper. However, persons skilled in the art will appreciate that other materials may be used, such as cardboard.

It will be appreciated that as the paper is wound onto the mandrel, the mandrel will carry an increasing number of paper layers. Generally, prior to being wound onto the mandrel, the paper is treated with adhesive. As the paper is wound onto the mandrel so that the paper builds up in layers, the adhesive bonds successive layers of paper to each other.

A portion should be understood to mean a section or segment of the planar material. For example, the portion may be a strip across the width or length of the planar material.

An adjacent layer should be understood to mean the layer of planar material overlaying a first layer of planar material. The adhesive treated portions and the reduced adhesive portions of each layer are such that in cross-section, there is a band of well bonded planar material and a band of less well bonded planar material.

It is important to note that the successive layers of the planar material are indexed or synchronised so that the bonded and weakly bonded portions of the planar material line up to form a band of bonded and weakly bonded planar material.

The resulting laminate material is constructed with portions that have weak or no adhesive bonding between the layers of the planar material forming the laminate material. These form controlled areas of weakness in the laminate material, which can be used as fold lines for the laminate material.

This is particularly advantageous as containers made from laminate material, not being previously collapsible, may now be collapsible for storage and transportation purposes.

The bonding of adhesive is improved when pressure is applied to the laminate material as it is formed. The application of pressure to the laminate material as it is formed is an important part of the manufacturing process.

According to yet another aspect of the present invention there is provided a collapsible container having at least one side,

characterised in that the side of the container is configured with a fold line, wherein the fold line corresponds to a controlled area of weakness.

A collapsible container is any container constructed with means that allow the container to be partially or fully flattened to reduce the volume occupied by the container for storage and/or transportation purposes.

In preferred embodiments of the present invention, the means that allows the container to be partially or fully flattened is a fold line.

A fold line should be understood to mean a line about which at least two of the sides of the container can be folded, thus reducing the width or volume of the container.

In preferred embodiments of the present invention, the container has four to eight fold lines, with at least one fold line for each side or corner of a rectilinear container, so that the container may be partially or fully flattened. However persons skilled in the art will appreciate that the number of fold lines and their location may vary according to the configuration of the container.

In preferred embodiments of the present invention, the collapsible container is made from fibreboard.

Fibreboard should be understood to mean a material constructed from a length of paper treated with adhesive, which is wound onto a mandrel. It will be appreciated that as the paper is wound onto the mandrel, the mandrel will carry an increasing number of paper layers.

In preferred embodiments of the present invention, the paper is Kraft paper. However, persons skilled in the art will appreciate that other materials may be used for constructing the collapsible container, such as cardboard.

Prior to being wound onto the mandrel, the paper is treated with adhesive, so that the successive layers of paper on the mandrel bond to each other.

In some embodiments of the present invention, pressure is applied to the paper by tensioning rollers acting on the paper prior to the paper being wound onto a mandrel. This tenses the paper against the contact surface of the mandrel sufficiently to encourage the bonding of successive layers of paper already on the mandrel.

The applicant has found that the effectiveness of the tensioning rollers can vary depending on the shape and configuration of the mandrel. For example, a mandrel with substantially right angled corners will bear the tensioning force mainly on the corners of the contact surface, rather than an even force across the contact surface. A mandrel with a substantially circular profile will bear the tensioning force more evenly across the contact surface of the mandrel.

In preferred embodiments of the present invention, a press roller may act against the layers of paper on the mandrel so that the layers of paper are pressed together to further encourage bonding between successive layers of paper. The press roller acts against the layers of paper by compressing them against the contact surface of the mandrel.

A mandrel should be understood to be a member for forming an object having substantially the same or a similar profile as the mandrel. The object is formed by winding a sheet of planar material around a contact surface of the mandrel, such that the material takes on the profile of the mandrel. It should be understood that the contact surface of the mandrel is the outer face of the mandrel.

The planar material may be any thin malleable material such as a sheet of paper, plastic film, cardboard or similar sheet material. Alternatively, the planar material may be held upon a reel or spool and unwound as required.

In preferred embodiments of the present invention, the planar material is Kraft paper. However, persons skilled in the art will appreciate that other materials may be used, such as cardboard.

The mandrel may be of any profile suitable for the manufacture of a container. For example, the profile of the mandrel may be circular or square in cross-section.

Persons skilled in the art will appreciate that the profile of the desired fibreboard container will ultimately determine the profile of the mandrel, but reference shall now be made to the mandrel having a substantially square profile, and the collapsible fibreboard container formed from this mandrel having a corresponding square profile in cross-section.

The mandrel may be manufactured from any suitable material such as a metal or alloy metal. Alternatively, the mandrel may consist of a metal or wood framework, to which sheets of aluminium or wood have been mounted, thus forming the contact surface.

A pressure relief area should be understood to mean an area of the contact surface of the mandrel to which the press roller is unable to be applied. For example, a pressure relief area may be the area either side of a protrusion rising from the contact surface of the mandrel. As the press roller has a circular profile, it is unable to apply pressure to the paper layers located immediately adjacent, or in the vicinity of where the protrusion arises from the contact surface.

This forms a weakly bonded area in the planar material which corresponds to the pressure relief area. Weakly bonded should be understood to mean that the bonding between adjacent layers of planar material corresponding to the pressure relief areas is weaker relative to elsewhere in the layers of planar material. Persons skilled in the art will appreciate that this does not necessarily mean that the weakly bonded areas of planar material lack strength.

In preferred embodiments of the present invention the pressure relief area is a groove in the contact surface of the mandrel. However, persons skilled in the art will appreciate that other methods of forming a pressure relief area in the contact surface of the mandrel are envisaged, which may depend on the material from which the mandrel is manufactured or on other factors such as the shape and configuration of the mandrel.

For example, a mandrel constructed from metal typically consists of a number of thin sheets of metal mounted to and supported by a metal frame. In this example, the pressure relief areas are formed by placing and securing the metal sheets upon the frame such that when assembled, there are gaps between the sheets that form the contact surface. These gaps form the pressure relief areas of the contact surface.

In another example, the pressure relief area may be formed using grooves either side of a protrusion from the contact surface. This can attenuate the effect of the protrusion upon the bonding of the paper layers on the mandrel.

Reference shall now be made to the pressure relief area as being a groove, although the term groove is not intended to be limiting. It will be appreciated forming pressure relief areas in the contact surface of a mandrel can be achieved in a number of ways readily apparent to a person skilled in the art, and the resulting discontinuities in the contact surface of the mandrel may be described in many ways.

A groove should be understood to mean an open channel, with a bottom and sides. In some embodiments of the present invention, the groove may not have a defined bottom. Instead, the bottom of the groove may be the interior of a substantially hollow mandrel.

A groove is preferred for a mandrel constructed from wood as it may be easier to machine a mandrel with a groove, rather than apply a protrusion running the length of the mandrel. A mandrel with a groove may be more robust than a mandrel with a protrusion applied. However, persons skilled in the art will appreciate that with suitable modifications a mandrel formed with a protrusion may be engineered to be just as robust as a grooved mandrel.

The dimensions of the groove, particularly its width, may vary according to the requirements of the fibreboard container being fabricated.

In preferred embodiments of the present invention, the groove extends substantially across the contact surface of the mandrel.

Preferably, the groove runs the width of the contact surface of the mandrel, parallel to the axis of rotation of the mandrel. However, persons skilled in the art will appreciate that the groove may run in the same direction as the direction of rotation of the mandrel. This may be useful when forming end flaps for the fibreboard container being formed.

It should be understood that the groove disrupts the continuity of the contact surface.

It should be appreciated that as the press roller passes over a groove, the contact surface of the mandrel is no longer able to act against the press roller to compress and therefore encourage the bonding of the paper layers situated immediately over the groove of the mandrel. As a result, the bonding between the layers of paper situated immediately over the groove of the mandrel is weaker than between paper layers elsewhere on the mandrel.

Because the paper layers situated immediately over the groove are weakly bonded, and thus are more malleable than the rigid paper layers elsewhere on the mandrel, they are able to function as fold lines for the container.

Placement of the grooves on the mandrel may also vary according to the requirements of the fibreboard container being fabricated. For example, the grooves may be at the corners of the mandrel.

However, the applicants have found that there is a significant advantage by placing the grooves near each corner of a square-profiled mandrel, if the mandrel is to be used with a press roller.

It will be appreciated that as the mandrel rotates, the press roller moves in and out relative to the axis of the mandrel such that it continues to apply pressure to the paper carried by the mandrel.

In practice, when the press roller is passing over a corner of the mandrel, there is a short time delay as the press roller transitions from an outward motion as it approaches the mandrel corner to an inward motion as it moves away from the mandrel corner.

This means that there is a reduction in pressure applied to the mandrel in the region immediately following the corner of the mandrel. Placing the grooves proximate to the corner of the mandrel further decreases the strength of the bond of the paper layers that are carried at this region of the mandrel.

In some embodiments of the present invention, grooves may be placed on both sides of the corner, such that each side of a square profiled mandrel has two grooves, each groove being situated in close proximity to the corners of the mandrel.

This embodiment may be necessary when forming particularly thick fibreboard containers. The width of the groove may be insufficient to allow a right angled hinge to be formed from a single fold line. Introducing an extra groove so that an additional fold line is formed allows the two main sides of the container to be at right angles to each other with an intermediate side (which approximates the corner of the mandrel) linking the main sides of the container.

This embodiment of the present invention also has the additional advantage of preserving the structural integrity of the corner portion of the fibreboard container. This is useful for important structural properties of the container. For example, this embodiment of the invention may be desired in the event that stronger protection of the corners of the articles or product being carried by the fibreboard container is required.

Preserving the corner structure of the fibreboard container also improves the strength of the container when being vertically stacked.

However, it will be appreciated by persons skilled in the art that placement of the grooves may also depend on the profile of the mandrel being used. For example, a circular mandrel may have no corners near which to place pressure relief areas.

In this event, the mandrel may be provided with four pressure relief areas evenly distributed around the contact surface of the mandrel, thus separating the mandrel into four arcs of 90°. The resulting fibreboard container would have four sides, each side forming an arc approximating 90° of a circle, separated from the neighbouring side by a fold line corresponding to the pressure relief area.

Alternatively, a mandrel may be provided with three pressure relief areas which could separate the mandrel into two 90° arcs and a single 180° arc. Therefore, one side of the resulting fibreboard container approximates a semicircle, with two smaller sides approximating 90° arcs.

Ultimately, it is the requirements of the user and the required fibreboard container which dictates the number and position of the pressure relief areas around the mandrel.

In some embodiments of the present invention, the pressure relief area is a groove or gap in the press roller. In this embodiment of the invention, the mandrel has a continuous contact surface, and the weakly bonded areas of the fibreboard container correspond to the grooves in the contact surface of the press roller as it passes over the paper carried by the mandrel.

Persons skilled in the art will appreciate that synchronisation of the press roller and mandrel is important in this embodiment of the invention. Consideration must be given to the respective size of the press roller and mandrel to ensure that the rotation of both the press roller and mandrel is synchronised such that the grooves in the press roller are consistently passing over the same area of the mandrel.

In some embodiments of the present invention, the weakly bonded areas of the fibreboard may be further mechanically worked to increase the effectiveness of the fold line formed by the mandrel or press roller.

For example, a blade may be passed along the fold line, such that an outer paper layer or layers are penetrated. This leaves the inner paper layer or layers acting as the hinge for the folding of the fibreboard container.

Alternatively, a small roller may be passed over the fold line to bend or tear some of the paper layers of the fold line.

This helps make the folding of the fibreboard container easier, particularly if the fibreboard container is formed from a large number of paper layers.

Persons skilled in the art will appreciate that either side of the fibreboard may be worked in this manner. For example, successive fold lines may be worked on their inside or outside, depending on the requirements of the user.

In use, paper treated with adhesive is wound about the mandrel. Pressure may be applied to the paper via a press roller, acting on the paper being carried by the mandrel as the mandrel rotates about its axle.

In conventional fibreboard container forming mandrels, the contact surface of the mandrel acts against the pressure applied to the paper thus compressing the successive layers of paper and enhancing the bonding of the adhesive treated paper layers.

In the present invention, across the area of the groove, the mandrel is unable to apply the compressive force to the successive layers of paper. This forms an area of weakness in the paper layers, which can be used as a fold such that the fibreboard container can be flattened.

In preferred embodiments of the present invention, the weakness in the bonding of the paper at the grooved portion of the contact surface of the mandrel may be further enhanced by engineering the press roller such that it is raised away from the paper carried on the mandrel as it passes over the pressure relief area.

This may be achieved through the use of cams or similar mechanisms. However, persons skilled in the art will appreciate that other mechanisms may be employed to the same effect.

This means that the press roller does not apply pressure to the paper corresponding to the location of the grooves of the mandrel.

The present invention offers some clear advantages over conventional fibreboard containers found in the prior art.
The fibreboard containers formed by the present mandrel and method are collapsible.
Collapsible fibreboard containers considerably reduce the space required for manufacture, storage and transport of such containers when empty, as well as increasing the total number of containers which may be stored or transported.
Furthermore, the disclosed collapsible fibreboard containers are able to be manufactured with little additional expense relative to the manufacture of conventional fibreboard containers.
It is possible to form fibreboard containers with corners that are relatively structurally uncompromised, offering greater protection for the articles being transported or stored.
Little alteration is required to convert a conventional fibreboard container assembly line to manufacture collapsible fibreboard containers. The alterations are limited to the substitution or modification of the mandrels or press rollers used for forming the containers.
Less manufacturing space is required for production of the improved fibreboard containers, thus the size of the production facilities may be reduced.

### BRIEF DESCRIPTION OF DRAWINGS

Further aspects of the present invention will become apparent from the following description which is given by way of example only and with reference to the accompanying drawings in which:

FIG. 1 a schematic showing the method of construction of a conventional fibreboard container;

FIG. 2 a schematic showing the present method of forming a collapsible fibreboard container according to one embodiment of the present invention;

FIG. 3 a cross section of the wall of a collapsible fibreboard container and mandrel according to one embodiment of the present invention;

FIG. 4a a cross section of one embodiment of the mandrel of the present invention;

FIG. 4b a cross section of a fibreboard container formed from the embodiment of the present invention illustrated in FIG. 4a;

FIG. 5a a cross section of another embodiment of the mandrel of the present invention;

FIG. 5b a cross section of a fibreboard container formed from the embodiment of the present invention illustrated in FIG. 5a;

FIG. 6a a cross section of another embodiment of the mandrel of the present invention;

FIG. 6b a cross section of a fibreboard container formed from the embodiment of the present invention illustrated in FIG. 6a;

FIG. 7a a cross section of the wall of a collapsible fibreboard container;

FIG. 7b a cross section of the wall of the collapsible fibreboard container illustrated in FIG. 6a, the wall being partially bent;

FIG. 7c a cross section of the wall of the collapsible fibreboard container illustrated in FIGS. 7a and 7b, the wall being bent to 90°;

FIG. 8a a cross section of the wall of another embodiment of a collapsible fibreboard container;

FIG. 8b a cross section of the wall of another embodiment of a collapsible fibreboard container, the wall having been mechanically worked;

FIG. 8c a cross section of the wall of another embodiment of a collapsible fibreboard container, the wall being bent to 90°;

FIG. 9 a schematic showing a method of mechanically working the wall of a collapsible fibreboard container;

FIG. 10 a schematic showing an alternative method of construction of a conventional fibreboard container;

FIG. 11 a schematic showing alternative method of forming a collapsible fibreboard container.

### BEST MODES FOR CARRYING OUT THE INVENTION

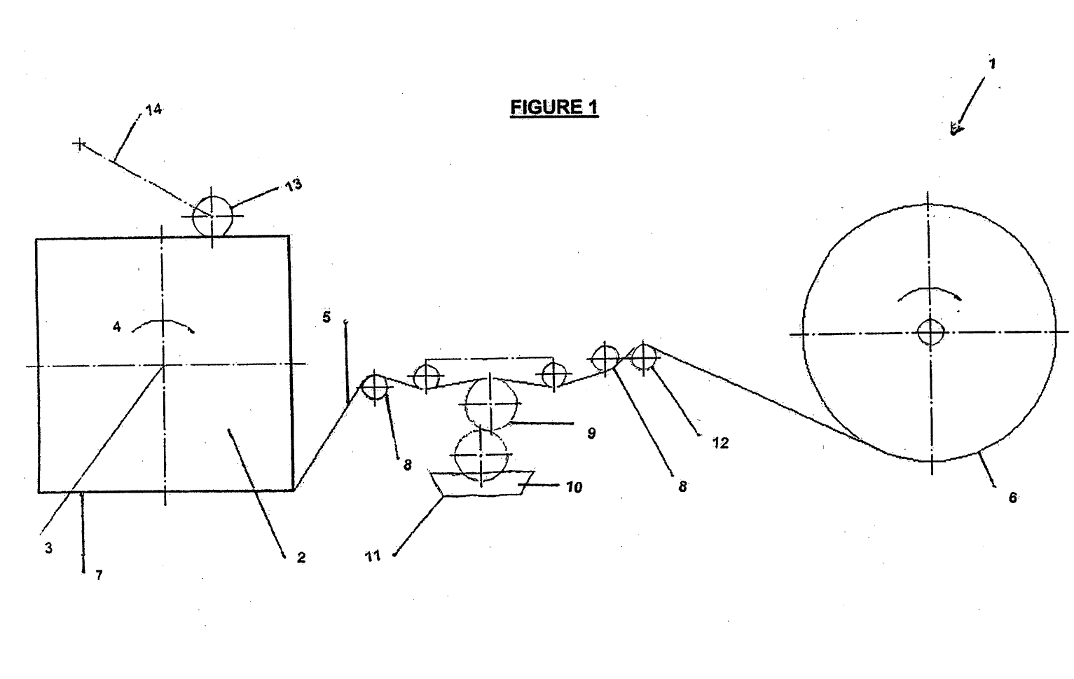

The method for forming fibreboard containers using conventional apparatus is illustrated in FIG. 1. The apparatus (generally indicated by arrow 1) includes a mandrel (2) mounted to rotate about an axle (3).

As the mandrel (2) rotates in the direction indicated by arrow 4, it draws paper (5) from a roll (6) onto the surface (7) of the mandrel (2).

In between the paper roll (6) and the mandrel (2) are a series of guide rollers (8) and glue contact rollers (9) which apply glue (10) from a glue bath (11) to the paper (5) before it is wound onto the mandrel (2).

The mandrel (2) and paper roll (6) are configured to rotate such that as the paper (5) is wound onto the mandrel (2) the adhesive treated side of the paper (5) faces outwards of the mandrel (2).

In some methods of forming fibreboard containers, the mandrel (2) and paper roll (6) are configured to rotate such that the adhesive treated paper (5) is placed facing inwards of the mandrel (2). In these methods, the first layer of paper (5) is not treated with adhesive.

The paper (5) may be tensioned by tensioning rollers (12) to ensure that the paper is taut as it is wound onto the mandrel. A brake (not shown) on the paper roll (6) also helps tension the paper (5)

Pressure may be applied using a press roller (13) on a pivoting arm (14). The press roller (13) acts against the mandrel (2) to encourage the bonding of successive layers (not shown) of paper (5) as it is wound upon the mandrel (2).

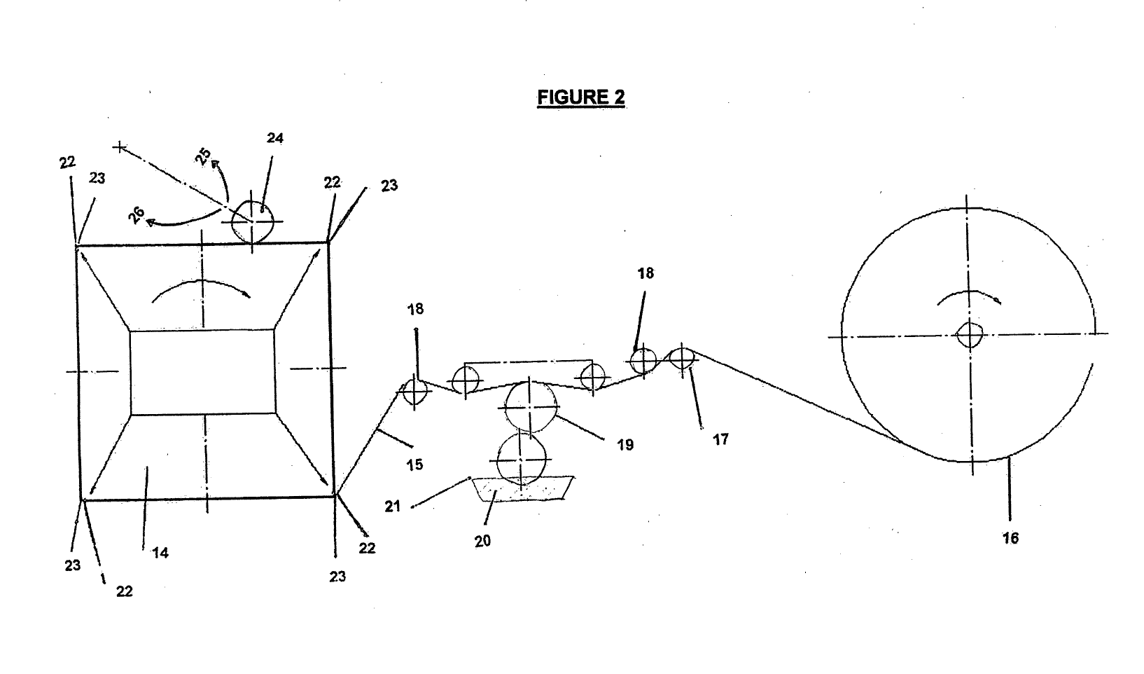

The present method is illustrated in FIG. 2.

A mandrel (14) draws paper (15) from a paper roll (16). The paper (15) is tensioned with a tensioning roller (17). Guiding rollers (18) ensure the paper (15) is kept straight and delivered to the mandrel (14).

Also between the mandrel (14) and the paper roll (16) is a glue roller (19) which applies glue (20) from a glue bath (21) to the paper (15).

The mandrel (14) is formed with grooves (22) close to the corners of the mandrel (23).

As the press roller (24) acts against the mandrel (14) to bond the successive layers (not shown) of paper (15), it applies a reduced pressure to the paper (15) overlaying the grooves (22) of the mandrel (14).

These grooves (22) therefore form areas of weakness in the wall of the resulting collapsible container (not shown).

This weakness is further enhanced by the movement of the press roller (24) away from the mandrel (14) in the direction of arrow 25 as the press roller (24) approaches the grooves (22). Once the mandrel (14) has sufficiently rotated such that grooves (22) pass under the roller, the press roller moves in the direction of arrow 26 to restore contact with the paper (15) on the mandrel (14)

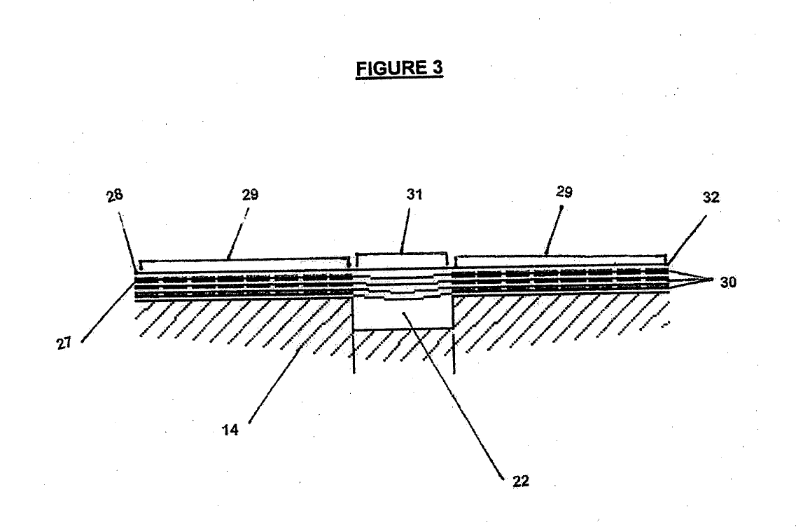

In FIG. 3, a cross section of the wall (27) of the collapsible container (28) is illustrated.

It will be appreciated that there are regions (29) where pressure has been applied, resulting in a strong bonding of the paper layers (30). However, there are regions (31) where the bonding has not been fully formed.

It will be appreciated that the area of weakness (31) corresponds to the location of the groove (22) of the mandrel (14).

Because of the groove (22), little or no compressing force can be applied to the multiple layers of paper (30) as the press roller (not shown) passes over the upper surface (32) of the layers of paper (30).

These areas of weakness (31) form the fold lines (not shown) of the collapsible container (not shown).

It will be appreciated that the fold lines (not shown) that are created can be varied according to the placement of the grooves (22) upon the mandrel (14).

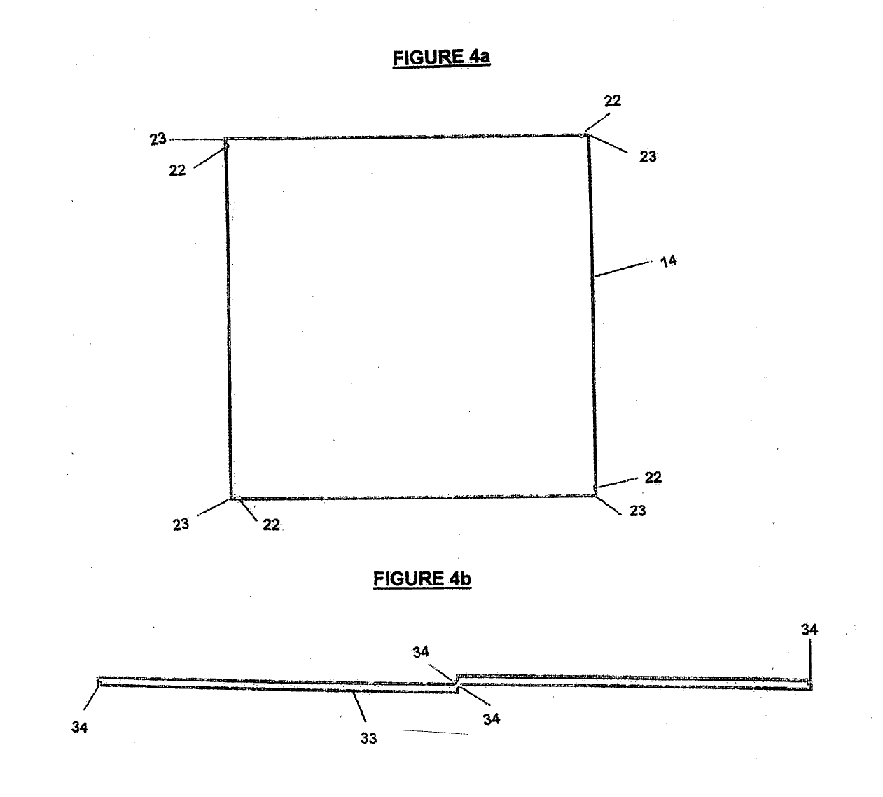

In FIG. 4a, a cross section of one embodiment of the mandrel (14) is shown. In this embodiment, the grooves (22) have been placed immediately adjacent the corners (23) of the mandrel (14).

The mandrel (14) illustrated in FIG. 4a forms the fibreboard collapsible container (33) illustrated in FIG. 4b. The container (33) is able to be folded about the foldlines (34) such that it is substantially flat.

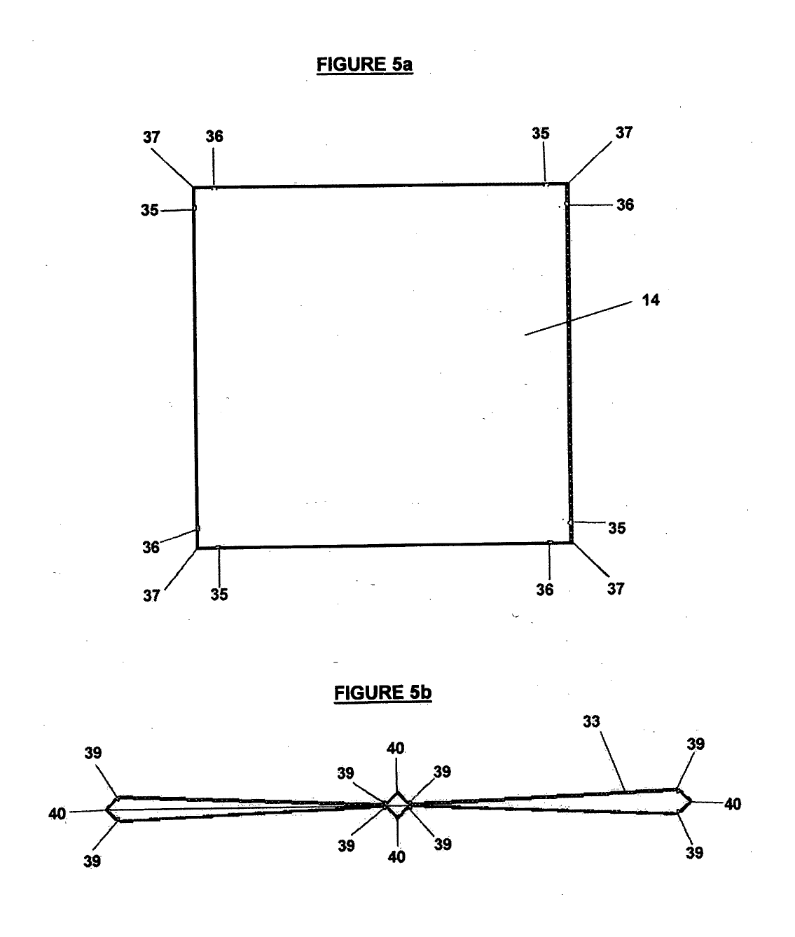

Another embodiment of the mandrel is illustrated in FIG. 5a. The mandrel (14) is illustrated with two grooves (35, 36) either side of each corner (37) of the mandrel (14). These grooves (35, 36) allow fibreboard containers to be folded, while preserving the integrity of the corners of the container.

The resulting collapsed fibreboard container (38) is illustrated in FIG. 5b. The dual grooves (not shown) of the mandrel (not shown) form dual fold lines (39). Separating the dual fold lines (39) is a corner (40) of the container (38).

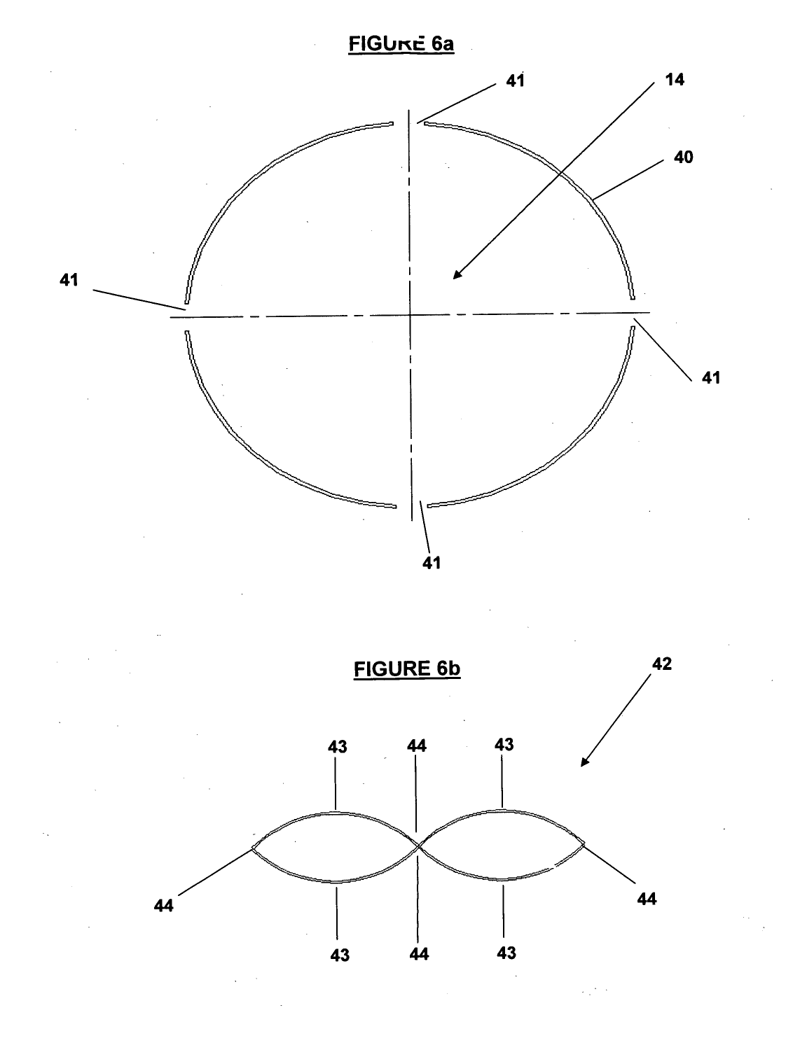

A mandrel (14) having a circular cross-section is illustrated in FIG. 6a. The mandrel is illustrated with grooves (41) arranged around the contact surface (40) of the mandrel (14). It will be noted that the location of the grooves (41) around the mandrel (14) are evenly distributed.

The resulting collapsed fibreboard container (42) is not fully flattened, but is substantially reduced in footprint. Each side (43) approximates an arc of 90°, separated by the fold lines (44).

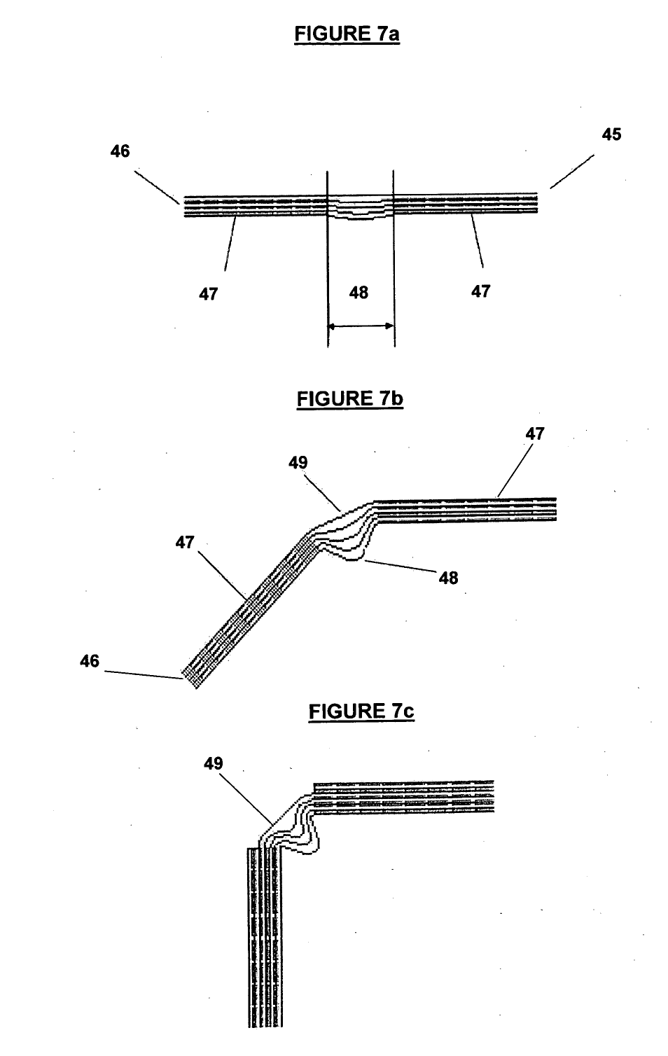

Turning now to FIGS. 7a-7c, which illustrate cross-sections of a fibreboard container (45) made up of many layers of paper (46).

The fibreboard container (45) includes regions of strong bonding (47) and weak bonding (48).

In FIG. 6b, the container is (45) beginning to be bent. The region of the weakly bonded layers (48), acts as a hinge or fold-line (49) about which the strongly bonded regions (47) can be bent.

The container (45) is able to be bent around the resulting fold line (49) in FIG. 6c.

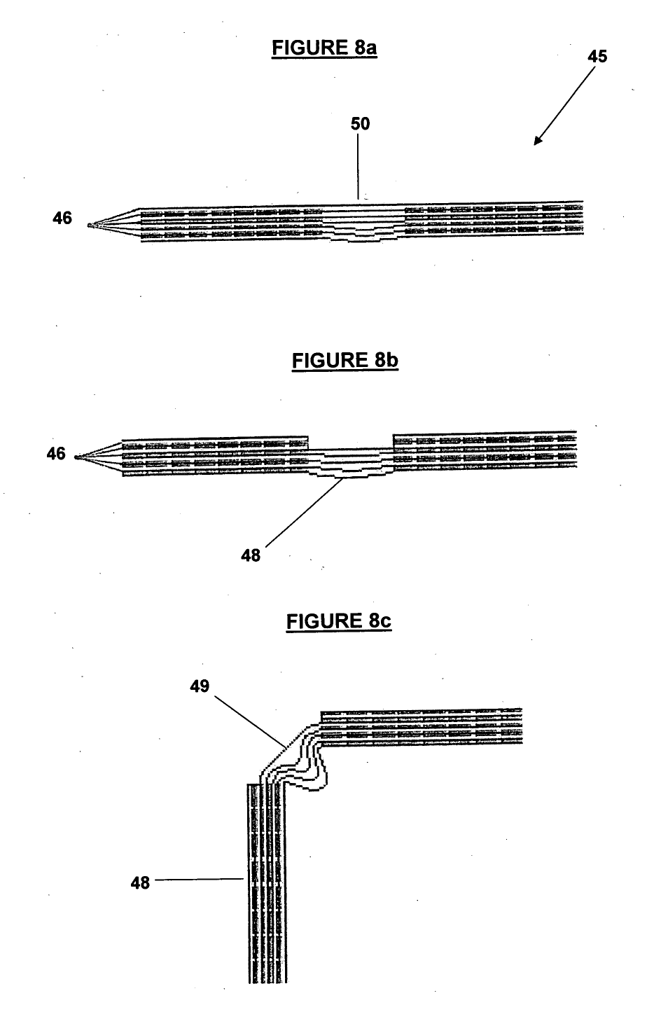

In some embodiments of the present invention, such as illustrated in FIGS. 8a, the container (45) consists of so many layers of paper (46), that there is some undesired bonding at the upper layer (50). This can make it more difficult to bend the paper (46).

To remedy this, the upper layer (50) is removed, as shown in FIG. 8b. This leaves the weakly bonded layers (48) to act as a hinge (49) as illustrated in FIG. 8c.

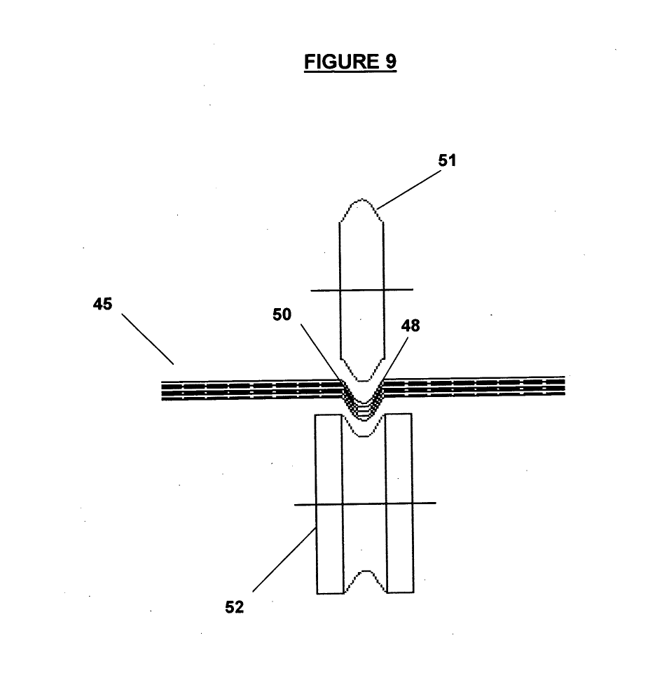

FIG. 9 illustrates a method of mechanically working the weakly bonded regions (48) of the container (45). A roller (51) runs over the upper layer (50) causing tearing of the upper layer (50) while distorting the remaining layers (48) against a corresponding roller (52). This allows for easier bending of the fibreboard container

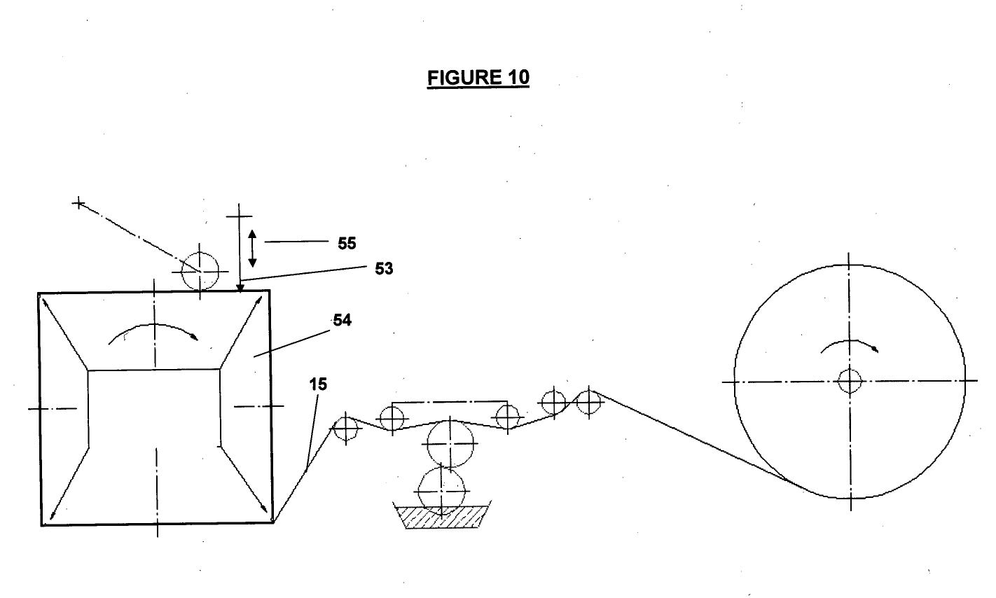

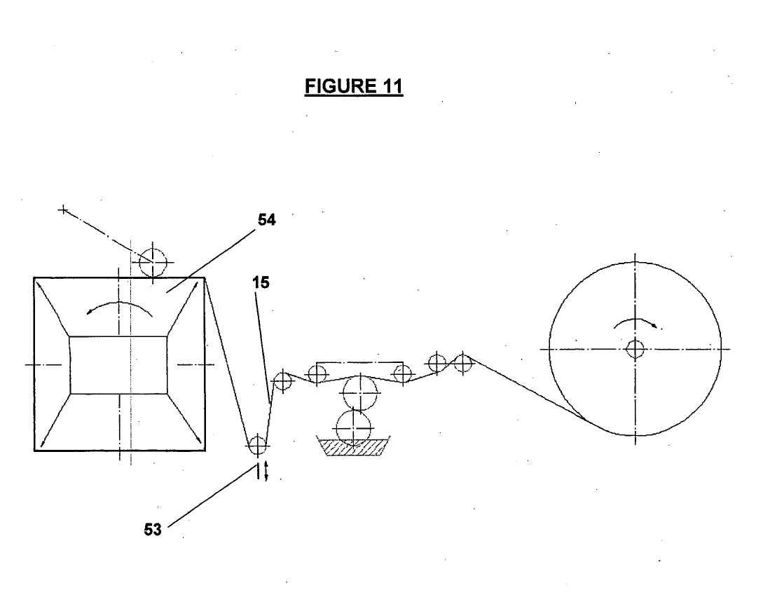

A further embodiment of the present invention is illustrated in FIGS. 10 and 11. Similar to FIG. 2, this embodiment includes a blade (53) acting on the paper (15) being carried by a mandrel (54). Adhesive (not shown) is applied to the outer side of the paper (15).

In this embodiment, the mandrel (54) is not provided with any pressure relief areas. Instead, the blade (53), which can move up and down in the direction indicated by arrow 55, contacts the surface of the paper (15) to remove any adhesive from a specific region of the paper (15).

The movement of the blade (55) is synchronised with the rotation of the mandrel (54) such that the blade only contacts specific regions of the paper (15). In this way, controlled areas of weakness (not shown) are formed, these areas of weakness (not shown) being the folding or hinging lines (not shown) of the resulting container (not shown).

It will be appreciated that the previous Figures describing the method of forming a collapsible fibreboard container depict the adhesive being applied to the outer surface of the paper. However, the present invention, suitably modified, may also be used when adhesive is applied to the inner surface of the paper as illustrated in FIG. 11.

In this embodiment, the mandrel (54) rotates in the opposite direction to previous embodiments described. Adhesive is applied to the paper (15) on the surface which is faces the mandrel.

Of course, to avoid the paper (15) inadvertently bonding to the mandrel (54), adhesive (not shown) may only be applied to paper (15) once an initial portion of paper (15) has been wound onto the mandrel (54).

In this embodiment, the blade (53) is positioned to act against the paper (15) prior to being wound onto the mandrel (54). This is in contrast to the embodiment illustrated in FIG. 10, in which the blade (53) acts on the paper (15) once it is held on the mandrel (54).

However, persons skilled in the art will appreciate that the blade (53) may be used in this manner regardless of whether the adhesive (not shown) is applied in the inside or outside of the paper (15).

Aspects of the present invention have been described by way of example only and it should be appreciated that modifications and additions may be made thereto without departing from the scope thereof as defined in the appended claims.

What I/we claim is:

1. A method of constructing a sheet of laminate material, the method including the steps of:
a) treating a sheet of planar material with an adhesive,
b) placing a second sheet of planar material against the first sheet such that the sheets bond together to form the sheet of laminate material,
characterised by the additional step of:
c) removing adhesive from a first portion of the first sheet of planar material such that substantially less bonding occurs between the first and second sheets of planar material at the portion of planar material from which adhesive has been removed than at a portion of planar material from which adhesive has not been removed, wherein the portion of the planar material from which adhesive has been removed forms a controlled area of weakness in the laminate material.

2. The method of constructing a sheet of laminate material as claimed in claim 1 including the additional steps of:
d) placing a third sheet of planar material against the second sheet of planar material, wherein the second sheet of planar material or the third sheet of planar material has been treated with adhesive,
e) removing adhesive from a second portion of the second or third sheets of planar material such that substantially less bonding occurs between the second and third sheets of planar material at the second portion than at a portion of planar material from which adhesive has not been removed, wherein the first portion of the first sheet of planar material and the second portion of the second sheet of planar material substantially correspond with each other to form a controlled area of weakness in the laminate material.

3. The method of constructing a sheet of laminate material as claimed in claim 1 wherein the adhesive is removed using a blade.

4. The method of constructing a sheet of laminate material as claimed in claim 3 wherein the adhesive is removed using absorbent material.

5. The method of constructing a sheet of laminate material as claimed in claim 1 wherein the planar material is kraft paper.

6. The method of constructing a laminate material as claimed in claim 1 wherein the laminate material is fibreboard.

7. A laminate material manufactured according to a method including the steps of:
a) treating a sheet of planar material with an adhesive,
b) placing a second sheet of planar material against the first sheet such that the sheets bond together to form the sheet of laminate material,
characterised by the additional step of:
c) removing adhesive from a first portion of the first sheet of planar material such that substantially less bonding occurs between the first and second sheets of planar material at the portion of planar material from which adhesive has been removed than at a portion of planar material from which adhesive has not been removed, wherein the portion of the planar material from which adhesive has been removed forms a controlled area of weakness in the laminate material.

8. A collapsible container manufactured from a laminate material manufactured according to a method including the steps of:
a) treating a sheet of planar material with an adhesive,
b) placing a second sheet of planar material against the first sheet such that the sheets bond together to form the sheet of laminate material,
characterised by the additional step of:
c) removing adhesive from a first portion of the first sheet of planar material such that substantially less bonding occurs between the first and second sheets of planar material at the portion of planar material from which adhesive has been removed than at a portion of planar material from which adhesive has not been removed, wherein the portion of the planar material from which adhesive has been removed forms a controlled area of weakness in the laminate material.

9. The collapsible container as claimed in claim 8 wherein the container has at least one fold line so that the container may be partially or fully flattened, wherein the fold line corresponds to a controlled area of weakness.

10. (canceled)

11. A method of constructing a laminate material from a sheet of planar material, the method including the steps of:
a) treating a sheet of planar material with an adhesive,
b) winding the planar material about a mandrel to form the laminate material from a plurality of layers of the planar material, and
characterised by the additional steps of:
c) removing adhesive from a first portion of a first layer of the planar material, and
d) removing adhesive from a portion of an adjacent layer of planar material corresponding to the first portion of the first layer of the planar material, wherein the portions of planar material from which the adhesive has been removed forms a controlled area of weakness in the laminate material.

12. The method of constructing a laminate material as claimed in claim ii wherein the adhesive is removed from the planar material using a blade.

13. The method of constructing a laminate material as claimed in claim 12 wherein the blade is fixed relative to the mandrel.

14. The method of constructing a laminate material as claimed in claim 12 wherein the blade is moveable relative to the mandrel.

15. The method of constructing a laminate material as claimed in claim 11 wherein the adhesive is removed from the planar material using absorbent material.

16. (canceled)

17. (canceled)

18. The method of constructing a laminate material as claimed in claim 11 wherein the planar material is kraft paper.

19. The method of constructing a laminate material as claimed in claim 11 wherein the laminate material is fibreboard.

20. An apparatus for use in constructing laminate material, wherein the apparatus includes
a blade, and
a mandrel onto which a sheet of planar material is being wound, and
a glue roller, the glue being configured to apply adhesive to the planar material, and
characterised in that the blade is configured to selectively remove adhesive from the sheet of planar material being wound onto the mandrel.

21. The apparatus according to claim 20, wherein the blade is configured to selectively remove adhesive from a sheet of planar material being wound onto the mandrel.

22. The apparatus as claimed in claim 21 wherein the blade is constructed from a flexible material.

23. The apparatus as claimed in claim 21 wherein the blade is moveable relative to the mandrel via a cam mechanism.

24. The apparatus as claimed in claim 21 wherein the blade is mounted to an articulated arm.

25. The apparatus as claimed in claim 11, characterised in that the mandrel is configured with chamfered corners.

26. A laminate material manufactured according to a method including the steps of:
a) a treating a sheet of planar material with an adhesive,
b) winding the planar material about a mandrel to form the laminate material from a plurality of layers of the planar material, and
characterised by the additional steps of:
c) removing adhesive from a first portion of a first layer of the material, and
d) removing adhesive from a portion of an adjacent layer of planar material corresponding to the first portion of the first layer of the planar material,
wherein the portions of planar material from which the adhesive has been removed forms a controlled area of weakness in the laminate material.

27. A collapsible container manufactured from a laminate material manufactured from the method including the steps of:
a) treating a sheet of planar material with an adhesive,
b) winding the planar material about a mandrel to form the laminate material from a plurality of layers of the planar material, and
characterised by the additional steps of:
c) removing adhesive from a first portion of a first layer of the planar material, and
d) removing adhesive from a portion of an adjacent layer of planar material corresponding to the first portion of the first layer of the planar material,
wherein the portions of planar material from which the adhesive has been removed forms a controlled area of weakness in the laminate material.

28. The collapsible container as claimed in claim 27 wherein the container has at least one fold line so that the container may be partially or fully flattened, wherein the fold line corresponds to a controlled area of weakness.

29. (canceled)

30. (canceled)

31. (canceled)

32. (cancelled)

33. (canceled)

34. (canceled)
